(19) United States
(12) Patent Application Publication
(10) Pub. No.: US 2009/0249194 A1
(43) Pub. Date: Oct. 1, 2009

(54) Method for Converting Electronic Documents

(76) Inventor: Michael Day, Carlton (AU)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/058,559

(22) Filed: Mar. 28, 2008

(51) Int. Cl. G06F 17/00

(52) U.S. Cl. 715/239

(57) ABSTRACT

A method and system for implementing a web page conversion involves one or more clickable conversion links on a web page. A conversion link can be represented by a clickable text, image, or image sequences. When a user clicks on a conversion link, a normal HTTP request is sent to a conversion server identified by the link. The conversion server looks at the ‘Referer’ header in the HTTP request to determine the URL of the web page that the user wants to convert. The conversion server fetches this web page (including text, images and other resources) through the HTTP protocol, converts it according to the type of conversion, and returns the converted page as a response to the initial HTTP request. The originating web page can be an HTML page, and the returned, converted page can be a PDF document, a WML page, or a JPEG image.

### FIELD OF THE INVENTION

The invention relates generally to conversion of electronic documents from one format to another. More particularly the invention relates to conversion of documents that are accessible from a first server in a second server before the document is sent in response to a request.

### BACKGROUND OF THE INVENTION

Computer users can use web browser to access a wide range of documents and other media types that are available on the Internet. The most common document type is HTML, or some other type of mark up language such as XHTML or XML, but other types of documents and media types are not unusual. In addition, mark up language documents often include other media types such as images, sound and video.

Documents that are accessible in this manner are typically available in the format that its author found most convenient for display in web browsers or similar user agents. However, users may often want to store or print documents such as web pages, and a format that is convenient for viewing in a browser is not necessarily convenient for printing or storing.

Consequently there is a need for easy conversion of web documents to other formats. Users are likely to desire easy access to such conversion without having to install any software or have any knowledge about file formats or media types.

### SUMMARY OF THE INVENTION

Briefly and in general terms, the present invention is directed toward a method of converting a document. In aspects of the present invention, the method comprises receiving, from a first computer, a request to convert a document, said request including an identification of said document to be converted, an address of said first computer, and an identification of a conversion method. The method further comprises requesting and receiving, from a second computer, said document to be converted, and executing a computer program capable of performing said identified conversion method, including using said received document to be converted as input for said computer program and generating converted data as output of said computer program. The method further comprises transmitting to said address of said first computer said converted output data.

In detailed aspects of the invention, said identification of said conversion method is embedded in said document to be converted. In other detailed aspects, said request from said first computer is a request according to a standard communication protocol which, if generated through user interaction with said embedded identification, includes an identification of said document to be converted.

In further aspects of the invention, said request from said first computer is an HTTP request, said identification of said document to be converted is a URL in a Refer field in said HTTP request, and said identification of a conversion method is the URL requested by said HTTP request. In still further aspects, said request from said first computer includes a parameter, and wherein executing said computer program further includes using said parameter as input for said computer program.

In other aspects of the present invention, the method involves converting a document in a network including a user computer, a remote computer storing said document to be converted, a conversion computer storing a conversion program, said remote computer in communication with the user and conversion computers. The method comprises providing a control element accessible on said document to be converted to allow a user to initiate conversion of said document to be converted, and transmitting a conversion request from said user computer to said conversion computer after user interaction with said control element, said conversion request including an identification of said document to be converted and an identification of a conversion method. The method further comprises transmitting a document request from said conversion computer to said remote computer, said document request including said document identification, and receiving said document to be converted from said remote computer in response to said document request. The method further comprises using said conversion program to generate a converted document based at least on said document to be converted and said conversion method identification, and transmitting said converted document from said conversion computer to said first computer.

The features and advantages of the invention will be more readily understood from the following detailed description which should be read in conjunction with the accompanying drawings.

### BRIEF DESCRIPTION OF THE DRAWINGS

FIG. 1 shows computers connected to a computer network and configured to operate in accordance with the invention;

FIGS. 2a and 2b shows the flow of information between the computers according to embodiments of the invention;

FIG. 3 is an example of a web page prepared for conversion using a method of the present invention; and

FIG. 4 is a flow chart of a method of converting a document in accordance with an embodiment of the invention.

### DETAILED DESCRIPTION OF THE PREFERRED EMBODIMENTS

The present invention is directed toward a computer implemented method for converting documents.

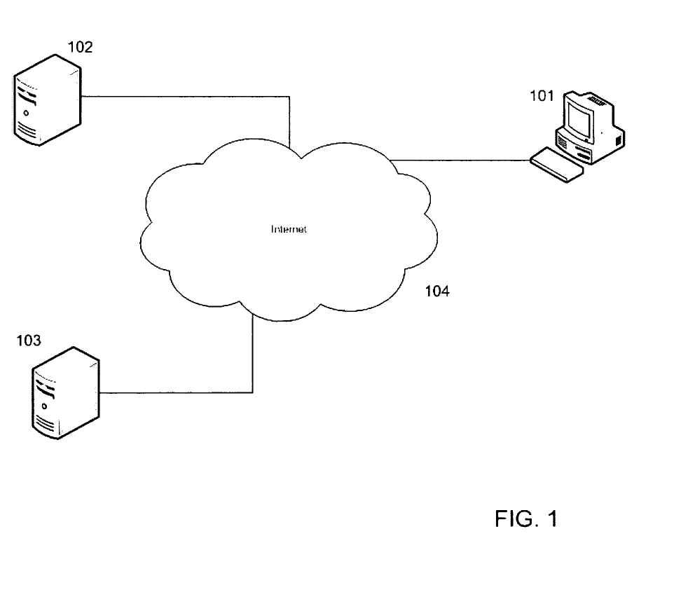

Referring now in more detail to the exemplary drawings for purposes of illustrating embodiments of the invention, wherein like reference numerals designate corresponding or like elements among the several views, there is shown in FIG. 1 a first computer 101 which may be a personal computer, and two servers 102, 103. The computer 101 and the servers 102, 103 are all connected to the Internet, over which they are capable of exchanging information using protocols that are well known by those with skill in the art. Examples of such protocols include TCP/IP and HTTP.

The first server 102 may be a web server configured to receive requests for resources such as documents and respond to a request by transmitting the requested resource to the requesting device. (For the sake of clarity requested and received resources will be referred to as documents and web pages, but these terms should not be interpreted as limitations.)

Typically the computer 101 may have a web browser installed thereon. A number of web browser applications are available from various providers, such as the OPERA browser from Opera Software, FIREFOX from the Mozilla Foundation, and INTERNET EXPLORER from Microsoft Corp. (OPERA, FIREFOX and INTERNET EXPLORER are trademarks.) Similarly, the server 102 may have a web server application installed thereon. Examples of web servers include Apache from the Apache Software Foundation and the Internet Information Server (ISS) from Microsoft Corp.

When a user of computer 101 directs the browser to a resource residing on web server 102, the browser application transmits a request to the web server 102 identifying the resource by its associated URL. The web server application receives the request, retrieves the resource and transmits it back to the computer 101 using an address included in the request. Hereinafter it will be assumed that the communication is based on TCP over IP, and that the requests are HTTP requests. These protocols are well known in the art. However, the invention is not limited to these protocols.

The requested resource is received at the computer 101 and may be displayed in a browser window on the computer's display.

Those with skill in the art will realize that the received document may include references to additional resources such that additional requests may have to be transmitted from the computer 101 before the resource can be displayed as intended. For the sake of clarity, and without loss of generality, such details will not be discussed in this specification except when necessary.

Consider now the situation where the user operating computer 101 desires to do something with the received web page other than view it in a browser window. For example, the user may desire to store the document for future viewing, to print the document, or to view it using a different application than a web browser. If this is the case, the original format of the web page may not be the most convenient format for the user. Most browsers are capable of sending a web page to a printer, but the result is not always as good as one could desire. Similarly, if a web page includes, in addition to a main document, a number of additional files such as embedded images and other types of media (often referred to as replaced content), it may not be convenient to store this collection of files for off-line access.

A user may therefore desire to convert the document to some other format. However, since a number of file formats and media types exist and are available from sites on the Internet, converting files on his or her own computer may require expensive software, and maybe even several different programs. An alternative is to send the document to a second server 103 for conversion. Such a second server may include one or more programs for conversion of documents between different formats. Following conversion the converted file or files may then be transferred to the computer 101.

In some embodiments of the invention, a web page residing on a web server 102 may include one or more links referencing a conversion server 103. Such links will in the present specification be referred to as conversion links. A conversion link may be represented by a clickable text, an image, or a sequence of images, in a manner that is well known in web page design. A conversion link may typically reference the conversion server 103 and a particular conversion program running on the conversion server by way of a URL. Such a URL may have the form of
http://www.conversionserver.com/print.cgi
   where “http” is the hypertext transfer protocol, “www.conversionserver.com” is a domain name that uniquely identifies the server that will perform the conversion, and “print.cgi” is the particular program to be used for this conversion, which may be a conversion to a printer friendly format.

A web page residing on the web server 102 may have its own URL, for example
http://www.webserver.com/webpage.html
   If this web page includes a clickable link to the conversion server 103, the user may click on this link while viewing the web page in his or her web browser on the computer 101. If the user does so, an HTTP request will be transmitted to the conversion server requesting the resource identified by the URL. In accordance with the HTTP protocol the HTTP request may include a “Referer” field which contains the URL of the web page that was referring to the URL that is requested. According to the example above, a HTTP request will be sent to “http://www.conversionserver.com/print.cgi” with the URL “http://www.webserver.com/webpage.html” in its Referer field. The conversion server 103 may now request the web page from the web server 102 using the provided URL, receive the web page, convert it using the print.cgi program and transmit the result of the conversion to the requesting computer 101 in response to the original HTTP request.

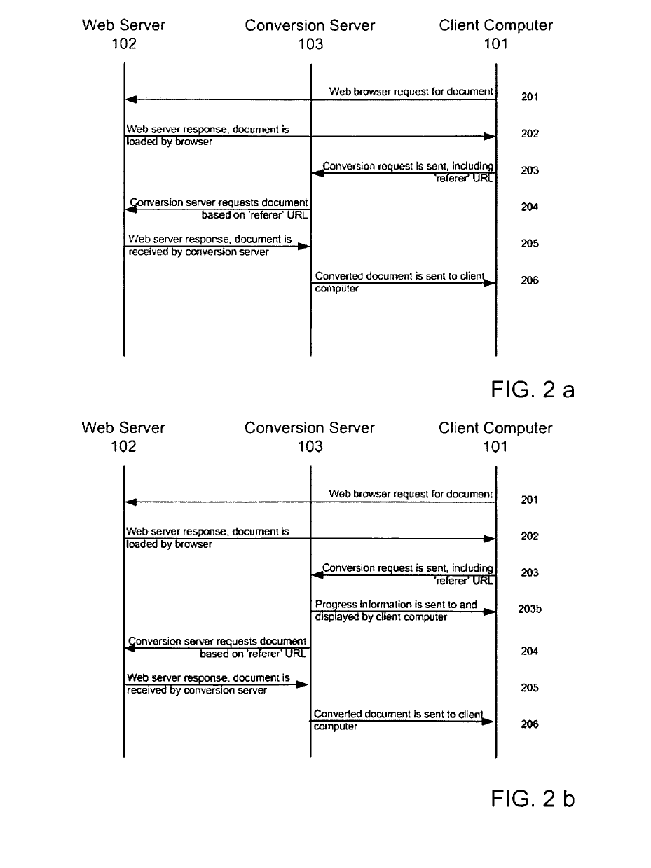

Reference is now made to FIG. 2a which illustrates the flow of messages exchanged between the computers shown in FIG. 1, according to an example.

In a first step 201 a request for a document residing on the web server 102 is sent from the client computer 101. According to some embodiments this request will be in the form of an HTTP request, but other alternatives are possible including HTTPS and other protocols known to those skilled in the art. As a response to this request, the web server 102 may respond by sending the requested document to the client computer in a step 202. As discussed above, the process of requesting and responding may involve a number of iterations, since certain files may be embedded in other files. If this is the case, the web browser installed on the client computer 101 may traverse the code of the first document, encounter embedded (or “replaced”) content, which may result in a new HTTP request being sent from the client computer 101. This may be repeated until all the files that are part of the requested document have been retrieved.

The user operating the client computer 101 may now choose to click on a link representing a conversion of the web document. Such a link may, according to an embodiment of the invention, be embedded in the web page such that it is represented as part of the web document in a browser window. In response to such an action the web browser application may cause a new HTTP request to be sent from the client computer 101 in a step 203, this time to the conversion server 103. The conversion link may, as described above, include the URL of a conversion resource on the conversion server 103, and the HTTP request may, in addition to this URL, include the URL of the web document within which the link was embedded. This second URL may be included in a ‘Referer’ field. The request may also include the address of the client computer 101.

The conversion server 103 may now receive the HTTP request from the client computer 101. The received HTTP request may now be examined by the conversion server 103 and information contained in the request may be retrieved. Based on the ‘Referer’ URL the conversion server 103 may send an HTTP request to the web server 102 requesting the same web document that was previously requested by the client computer 101, in a step 204. Again the web server responds to the HTTP request by sending 205 the web document to the requesting computer. Following receipt of the web document at the conversion server, 103 the conversion server invokes the resource identified in the HTTP request received from the client computer 101 and delivers the web document as input. The resource may be a computer program that takes data of one format as input and converts it to data of a second format which is delivered as output.

The converted data is sent to the client computer 101 as response to the HTTP request 203 in a step 206. The converted data may be handled at the client computer according to the configuration of the web browser and the wishes of the user operating the computer.

FIG. 2b shows an alternative to the progress illustrated in FIG. 2a, wherein the conversion server 103 transmits progress information to the requesting client computer 101 in a step 203b after receiving the request in step 203 and before requesting the web page in step 204.

According to some embodiments of the invention, progress information is static, and just shows an animated icon while periodically refreshing the page. According to other embodiments actual progress may be reflected using JavaScript to query the server in the background. According to one embodiment, the progress information includes an advertisement or some other information that may be displayed for a fixed time period, e.g. 10 seconds. The page may then be refreshed to download the generated PDF document.

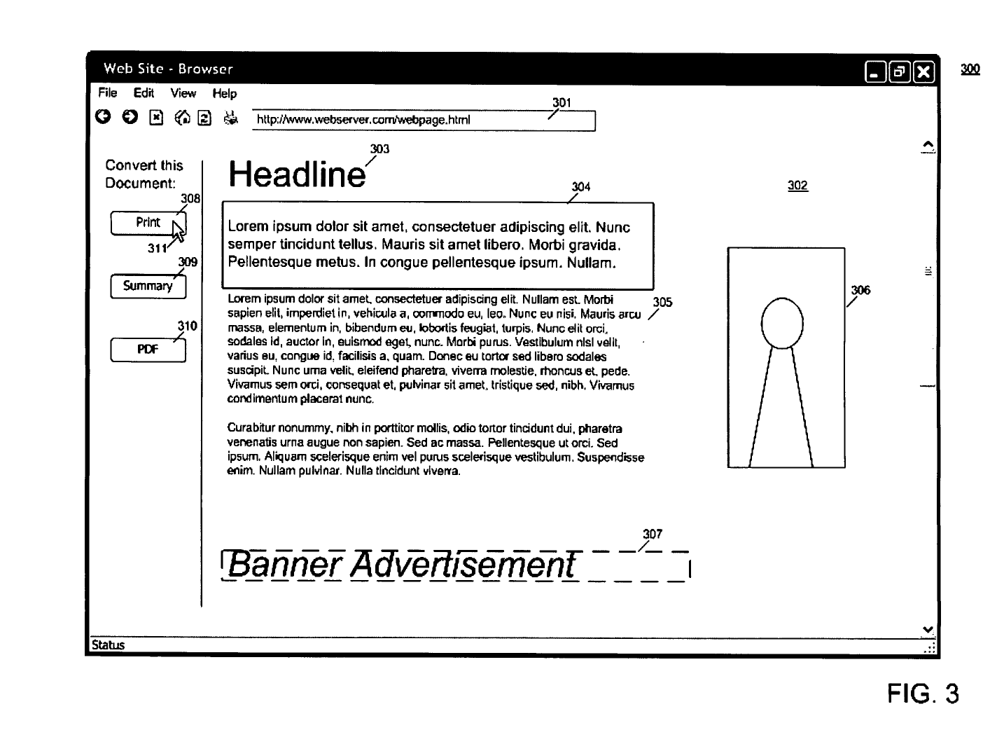

Turning now to FIG. 3, an exemplary user interface 300 of a web browser running on the client computer 101 is shown. The user interface includes a number of controls that are well known in the art and that for the sake of brevity will not be discussed, including such elements as toolbar buttons and menus. In addition the user interface may include an address field 301 wherein the address, or URL, of a web site may be entered. When such a URL is entered, the web browser may cause a HTTP request to be sent to the server defined as part of the URL, requesting the relevant resource, as explained above.

When a resource such as a web page has been received by the web browser in response to a HTTP request, the web page may be displayed in a web browser window 302. An exemplary web page is illustrated in FIG. 3, including a number of elements that have been included by a web designer or author. A first element may be a headline 303, followed by an introduction 304 and body text 305. Additional elements may include an image 306 and a banner advertisement 307. Images and advertisements may be static images or animated or interactive elements.

Consistent with embodiments of the invention, the example in FIG. 3 includes three conversion links included by the web page author. Each conversion link may represent one type of conversion. For example, a link labeled “print” 308 may represent a print conversion, and a link labeled “summary” may represent a summary conversion 309. A third link may represent a conversion to a well known file format known as Portable Document Format, but most often referred to as PDF.

When a user wants to perform a web page conversion, he/she follows the link by clicking on it using an input device such as a mouse, which may be represented on the display as a mouse pointer 311. As a result, a normal HTTP request is sent to a conversion server identified by the link. The conversion server looks at the ‘Referer’ header in the HTTP request to determine the URL of the web page that the user wants to convert. The conversion server fetches this web page (including text, images and other resources) through the HTTP protocol, converts it according to the type of conversion, and returns the converted page as a response to the initial HTTP request. While the user waits for the conversion to take place, he/she may be shown progress information (e.g. a progress bar or advertising). The converted page can be in a different format from the originating web page. For example, the originating web page can be an HTML page, and the returned page can be a PDF document, a WML page, or a JPEG image.

An example of HTML code that may represent the three links illustrated in FIG. 3 may read in part as follows:

<a href=“http://www.conversionserver.com/print.cgi”>Print</a>
<a href=“http://www.conversionserver.com/summary.cgi”>Summary</a>
<a href=“http://www.conversionserver.com/pdf.cgi”>PDF</a>

where print.cgi, summary.cgi and pdf.cgi may refer to three different conversion programs residing on the server referenced by www.conversionserver.com. According to an example consistent with embodiments of the invention, the first program, print.cgi, may convert HTML documents and embedded content such as images to a format suitable for printing, for example encapsulated post script, or EPS. Optionally, the program may remove information that is not relevant to a version printed on paper, such as the conversion links 308, 309, 310.

The second program, summary.cgi, may take only the HTML document itself as input, ignoring images and banners, and removing such information as body text and links, e.g. based on HTML tags. According to such an example a summary of the web page illustrated in FIG. 3 would retain only the headline 303 and the introduction 304.

The third program, identified as pdf.cgi, may convert the web page to a PDF file. Again the conversion program may remove irrelevant information, such as the conversion links and the banner ad, while text and images are retained.

Additional types of conversions are within the scope of the invention. One example of a type of conversion consistent with some embodiments of the invention may be referred to as “bookbinding”. According to this type of conversion the conversion server 103 returns not only the converted originating web page, but a collection of related pages. For example, in an online encyclopedia, the conversion server 103 may return a collection of articles related to the originating web page.

The conversion programs may, in addition to the file or files defined by the URL in the ‘Referer’ field of the request, take additional input.

According to a first embodiment, the conversion programs contain all information regarding how the conversion should be performed.

According to a second embodiment of the invention, the conversion may, in full or in part, be determined by a style sheet residing on the web server 102. In this case the style sheet may be invoked as part of the link 308, 309, 310 on the web page.

According to a third embodiment, parameters to the conversion process may be transmitted in the URL of the incoming request. For example, the orientation (landscape vs. portrait) of the returned page can be set as a parameter in the URL:

http://www.example.com/printit.cgi?paper=A4&orient=landscape

According to a fourth embodiment, parameters may also be stored as “cookies” on the conversion server 103. For example, in advance of the conversion request, a user can set parameters by visiting a web page on the conversion server. The web page allows the user to set parameters to the conversion process (e.g., paper size of the returned page: A4 or “us-letter”) and these parameters are stored in a “cookie”.

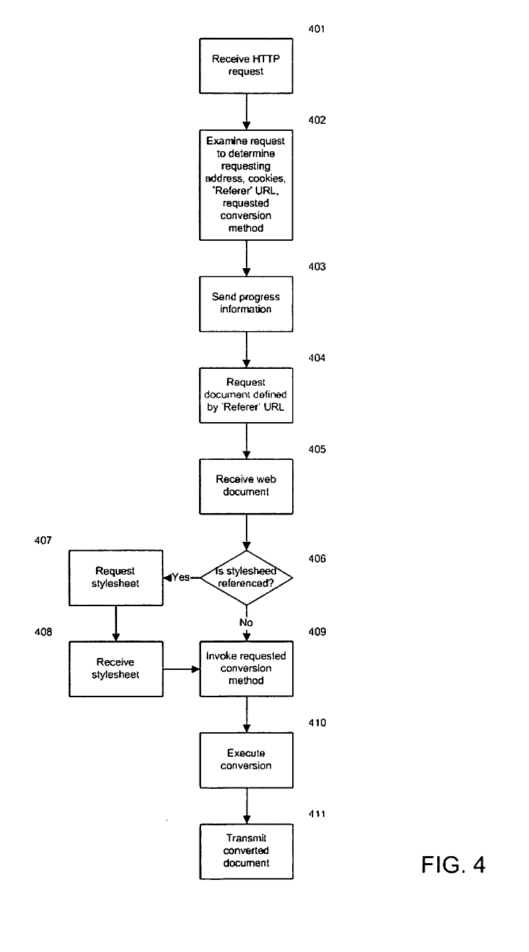

Turning now to FIG. 4, a flowchart illustrates the conversion process as it may progress in the conversion server 103 according to embodiments of the invention.

In a first step 401 a conversion request is received from a requesting client computer. The request is examined in a step 402 in order to determine which conversion method is reqested, the ‘Referer’ URL and the address of the requesting computer. According to some embodiments of the invention the request may also be examined to determine if the request includes cookies or references to style sheets.

According to some embodiments, progress information may be returned to the requesting computer in a step 403. The progress information may include static information, animations or other relevant information. The progress information may also include an instruction to the web browser to refresh this information after a predetermined period of time. As described above, the progress information may also include a JavaScript that queries the server in the background and displays actual progress to the user of the client computer.

The conversion server may now proceed to request the document defined by the URL in the ‘Refer’ field of the request in a step 404. Following receipt of the requested document in step 405, the server may, according to some embodiments of the invention, determine whether also a style sheet is requested in the original request received from the client computer in step 401, or alternatively as part of the document received from the web server in step 405. If, in step 406, this is determined to be the case, the referenced style sheet is requested from the web server in step 407. In step 408 the requested style sheet is received form the web server. When the conversion server has all necessary information available, the requested conversion method is invoked in step 409. At this point all relevant information is passed to the method or program as input parameters. This may, in addition to the web document itself include any cookies, style sheets or other parameters available.

In step 410 the actual conversion is performed, and the resulting document is created in accordance with criteria defined by the program itself and the parameters delivered as input. This document may now be transmitted to the requesting computer. According to some embodiments the converted document may be transmitted immediately as a response to the original HTTP request 401. According to other embodiments, the document is sent in response to a new HTTP request received as a result of a refresh command included in progress information sent in a first response to the initial request, in step 403.

While several particular forms of the invention have been illustrated and described, it will also be apparent that various modifications can be made without departing from the scope of the invention. It should be understood that additional variations and features are within the scope of the invention. By way of example, the conversion server could be configured only to accept conversion requests if the URL of the document to be converted, or a prefix to the URL such as the domain, exists in a list of approved URL's (or domains). Alternatively, other methods to authorize either the site of the document or the user may be employed, such as password authentication of pre-approved users.

It will be understood by those with skill in the art that the various computers or servers referred to in this specification may by any computing device capable of processing documents and handling requests as described. In principle the client computer as well as the servers may therefore be any type of device including, but not limited to, personal computers, server computers, personal digital assistants (PDA), and even cell phones.

It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. A method for converting a document, comprising:
receiving, from a first computer, a request to convert a document, said request including an identification of said document to be converted, an address of said first computer, and an identification of a conversion method;
requesting and receiving, from a second computer, said document to be converted;
executing a computer program capable of performing said identified conversion method, including using said received document to be converted as input for said computer program and generating converted data as output of said computer program; and
transmitting to said address of said first computer said converted output data.

2. The method according to claim 1, wherein said identification of said conversion method is embedded in said document to be converted.

3. The method according to claim 2, wherein said request from said first computer is a request according to a standard communication protocol which, if generated through user interaction with said embedded identification, includes an identification of said document to be converted.

4. The method according to claim 1, wherein said request from said first computer is an HTTP request, said identification of said document to be converted is a URL in a Refer field in said HTTP request, and said identification of a conversion method is the URL requested by said HTTP request.

5. The method according to claim 1, wherein said request from said first computer includes a parameter, and wherein executing said computer program further includes using said parameter as input for said computer program.

6. The method according to claim 1, further comprising storing a parameter set by a user of said first computer prior to receiving said request from said first computer; and wherein executing said computer program further includes using said parameter as input for said computer program.

7. The method according to claim 1, further comprising:
determining whether a style sheet is referenced in said request from said first computer or said document to be converted; and
requesting and receiving said style sheet;
wherein executing said computer program further includes using said style sheet as input for said computer program.

8. The method of claim 1, further comprising transmitting progress information to said first computer after receiving said request from said first computer.

9. The method of claim 1, further comprising using a web browser installed on said first computer to generate said request from said first computer.

10. The method of claim 9, further comprising using a link on a web page displayed on said web browser to generate said request from said first computer.

11. The method of claim 1, further comprising using a web server installed on said second computer to provide said document to be converted in response to said request from said first computer.

12. The method of claim 1, wherein said document to be converted is in an HTML format and said converted data is in a PDF, WML or JPEG format.

13. A method for converting a document in a network including a user computer, a remote computer storing said document to be converted, a conversion computer storing a conversion program, said remote computer in communication with the user and conversion computers, the method comprising:
providing a control element accessible on said document to be converted to allow a user to initiate conversion of said document to be converted;
transmitting a conversion request from said user computer to said conversion computer after user interaction with said control element, said conversion request including an identification of said document to be converted and an identification of a conversion method;
transmitting a document request from said conversion computer to said remote computer, said document request including said document identification;
receiving said document to be converted from said remote computer in response to said document request;
using said conversion program to generate a converted document based at least on said document to be converted and said conversion method identification; and
transmitting said converted document from said conversion computer to said first computer.

14. The method of claim 13, wherein said conversion request further includes a parameter, and said converted document is further based on said parameter.

15. The method of claim 14, wherein said parameter has a value selected by a user and is stored on said conversion computer.

16. The method of claim 13, wherein said conversion request or said document to be converted references a style sheet, and said converted documented is further based on said style sheet.

17. The method of claim 13, further comprising transmitting progress information from said conversion computer to said user computer in response to said conversion request.

18. The method of claim 13, wherein said document to be converted is an HTML page and the converted document is any one of a PDF document, a WML page, and a JPEG image.
